(19) United States
(12) Patent Application Publication
(10) Pub. No.: US 2011/0235491 A1
(43) Pub. Date: Sep. 29, 2011

(54) OPTICAL RECORDING MEDIUM AND OPTICAL RECORDING METHOD

(76) Inventors: Shuji TSUKAMOTO, Tokyo (JP); Hiroyasu Inoue, Tokyo (JP)

(21) Appl. No.: 13/070,634

(22) Filed: Mar. 24, 2011

(30) Foreign Application Priority Data
Mar. 25, 2010 (JP) 2010-069484

(51) Int. Cl. G11B 7/00; B32B 3/02

(52) U.S. Cl. 369/100; 428/64.4; G9B/7

(57) ABSTRACT

An optical recording medium having a good power margin during recording is provided. In an optical recording medium, a Cu recording layer that includes Cu as a main component, a first Si recording layer that is arranged adjacent to the cover layer side of the Cu recording layer and includes Si as a main component, and a second Si recording layer that is arranged adjacent to the substrate side of the Cu recording layer and includes Si as a main component, are stacked between the substrate and the cover layer.

### BACKGROUND OF THE INVENTION

1. Field of the Invention

The present invention relates to an optical recording medium and an optical recording method for recording information on such an optical recording medium, and in particular, to a technology for improving a power margin when recording information.

2. Description of the Related Art

Conventionally, optical recording media such as CDs, DVDs, and Blu-Ray Discs (BD) have been widely utilized to view digital moving image contents and to record digital data. Among these, BD, which is one of the next-generation DVD standards, shortens the wavelength of the laser light used in recording and reading to 405 nm, and sets the numerical aperture of the objective lens to 0.85. An optical recording medium side compliant with the BD standard is capable of recording and reading of 25 GB or more per information recording layer.

Types of such recording media include write-once recording media and rewritable recording media. Write-once recording media have a function which allows information to be written onto their recording layer only once. Examples thereof include standards such as CD-R, DVD+/−R, Photo CD, and BD-R. Rewritable recording media have a function which allows information to be repeatedly written onto their recording layer. Examples thereof include standards such as CD-RW, DVD+/−RW, DVD-RAM, and BD-RE.

Not only is there a need for an improvement in the recording properties of write-once recording media, but write-once recording media also need to be made durable enough so that the initial recorded information can be maintained for a long duration without deteriorating. Further, with the recent increasing awareness about global environmental problems, write-once recording media also need to be formed using constituent materials that have a low impact on the environment.

Japanese Patent Application Laid-Open No. 2004-5922, for example, proposes a technology in which, as a write-once recording medium recording layer, a first layer including as a main component an element selected from the group consisting of Si, Ge, Sn, Mg, In, Zn, Bi, and Al is arranged on a light incident surface side, and a second layer including Cu as a main component is arranged on a substrate side. By employing a recording layer having this dual-layer structure, when using laser light to record information, a region is formed in which the element included as the main component in the first recording layer and the element included as the main component in the second recording layer are mixed, which enables reflectivity to be substantially changed. Further, the information can be recorded at a good sensitivity, and that information can be stored for a long period. Especially, this also has the advantage of enabling recording and reading to be realized even for the BD standard, which uses blue laser light.

However, with the conventional optical recording medium described in Japanese Patent Application Laid-Open No. 2004-5922, the power margin when recording information on the recording layer is narrow. Consequently, there is the problem that the recording power of the laser has to be controlled with a high degree of precision even on the light pickup side.

### SUMMARY OF THE INVENTION

The present invention was made in view of the above-described problem. Accordingly, it is an object of the present invention to provide an optical recording medium having an improved recording power margin property.

As a result of the diligent research performed by the present inventors, the above object is achieved on the basis of the following means.

Specifically, the present invention for achieving the above object is an optical recording medium including: a substrate; a cover layer; a Cu recording layer that is arranged between the substrate and the cover layer and includes Cu as a main component; a first Si recording layer that is arranged adjacent to the cover layer side of the Cu recording layer and includes Si as a main component; and a second Si recording layer that is arranged adjacent to the substrate side of the Cu recording layer and includes Si as a main component.

In the optical recording medium for achieving the above object according to the above invention, the second Si recording layer may have a thickness T2 that is set to 0 nm<T2≦4 nm.

In the optical recording medium for achieving the above object according to the above invention, the first Si recording layer may have a thickness T1 that is set to 0 nm<T1≦8.5 nm.

In the optical recording medium for achieving the above object according to the above invention, the second Si recording layer may have a thickness T2 that is set to 1 nm≦T2≦4 nm.

In the optical recording medium for achieving the above object according to the above invention, the first Si recording layer may have a thickness T1 that is set to 3.5 nm≦T1≦8.5 nm.

In the optical recording medium for achieving the above object according to the above invention, the thickness T2 of the second Si recording layer is set to be smaller than the thickness T1 of the first Si recording layer.

The optical recording medium for achieving the above object according to the above invention may further include a first dielectric layer that is arranged adjacent to the cover layer side of the first Si recording layer, and a second dielectric layer that is arranged adjacent to the substrate side of the second Si recording layer.

The present invention for achieving the above object is also an optical recording method for recording information by irradiating a laser beam on an optical recording medium having an information recording layer between a substrate and a cover layer, the method including: providing, as the information recording layer, a Cu recording layer that includes Cu as a main component, a first Si recording layer that is arranged adjacent to the cover layer side of the Cu recording layer and includes Si as a main component, and a second Si recording layer that is arranged adjacent to the substrate side of the Cu recording layer and includes Si as a main component, and chemically or physically modifying the Cu recording layer, the first Si recording layer, and the second Si recording layer simultaneously by heat from the laser beam.

According to the present invention, an optical recording medium can be provided that has an excellent power margin property while also maintaining a high level of signal quality during reading.

### BRIEF DESCRIPTION OF THE DRAWINGS

FIG. 1 is a block diagram illustrating an optical recording medium according to an embodiment of the present invention and the whole configuration of an optical pickup used in recording and reading performed on such optical recording medium;

FIG. 2 is a cross sectional view illustrating a layer structure of this optical recording medium;

FIG. 3 is a diagram illustrating jitter variation of the optical recording medium according to the embodiment with the variation caused by changes in the recording power;

FIG. 4 is a diagram illustrating asymmetry variation of the optical recording medium according to the embodiment with the variation caused by changes in the recording power;

FIG. 5 is a diagram illustrating reflectivity of the optical recording medium according to a verification example during an unrecorded state;

FIG. 6 is a diagram illustrating a degree of modulation of the optical recording medium according to the verification example during optimum recording power Po;

FIG. 7 is a diagram illustrating a minimum value of LEQ jitter (bottom jitter) for the optical recording medium according to the verification example;

FIG. 8 is a diagram illustrating a power margin of the optical recording medium according to the verification example; and

FIG. 9 is a diagram illustrating the optimum recording power Po for the optical recording medium according to the verification example.

### DETAILED DESCRIPTION OF THE PREFERRED EMBODIMENTS

An embodiment according to the present invention will now be described with reference to the attached drawings.

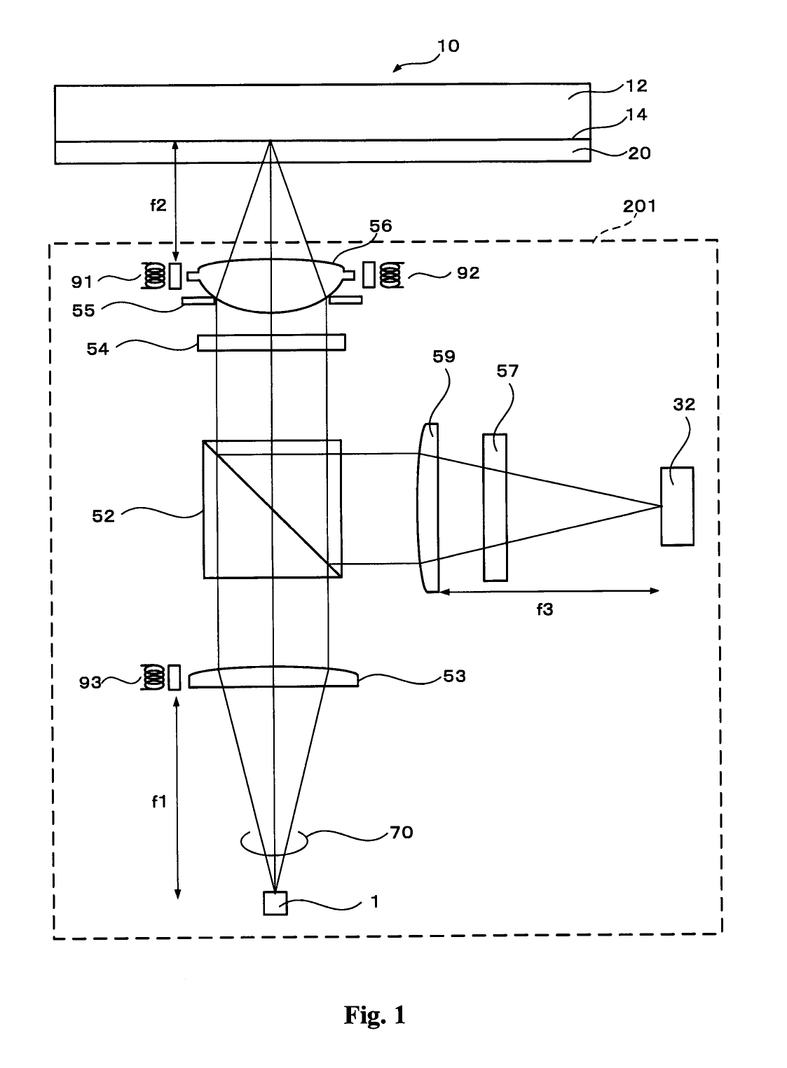

FIG. 1 illustrates the configuration of an optical recording medium 10 according to the present embodiment, and the configuration of an optical pickup 201 used in recording and reading performed on this optical recording medium. A divergent beam 70 output from a light source 1 having a wavelength of 380 to 450 nm (here, 405 nm) is transmitted through a collimating lens 53, which has a focal length f1 of 15 mm and which includes spherical aberration correction means 93, and is incident on a polarization beam splitter 52. The beam 70 incident on the polarization beam splitter 52 is transmitted through the polarization beam splitter 52, and then transmitted through a quarter-wave plate 54, whereby the beam is converted into a circularly-polarized light beam. This circularly-polarized light beam is then converted into a convergent beam by an objective lens 56 that has a focal length f2 of 2 mm. This beam is transmitted through a cover layer 20 of the optical recording medium 10, and concentrated on a recording and reading layer 14 formed between a support substrate 12 and the cover layer 20.

The opening of the objective lens 56 is limited by an aperture 55, and the numerical aperture NA is set at 0.70 to 0.90 (here, 0.85). The beam 70 reflected by the recording and reading layer 14 is transmitted through the objective lens 56 and the quarter-wave plate 54, converted into linear polarized light beam that is 90° different from the outward path, and then reflected by the polarization beam splitter 52. The beam 70 reflected by the polarization beam splitter 52 is transmitted through a condenser 59 having a focal distance f3 of 10 mm, and converted into convergent light, which passes through a cylindrical lens 57 and is incident on a light detector 32. The beam 70 is made astigmatic when it passes through the cylindrical lens 57.

The light detector 32 has four not-illustrated light receiving units, and outputs a current signal based on the light amount received by each unit. Based on these current signals, for example, a focus error (hereinafter, “FE”) signal is generated by an astigmatic method, a tracking error (hereinafter, “TE”) signal is generated by a push pull method, and a reading signal about the information recorded in the optical recording medium 10 is generated. The FE and TE signals are amplified to a desired level and phase compensated to be fed back to the actuators 91 and 92, thereby achieving focusing and tracking controls.

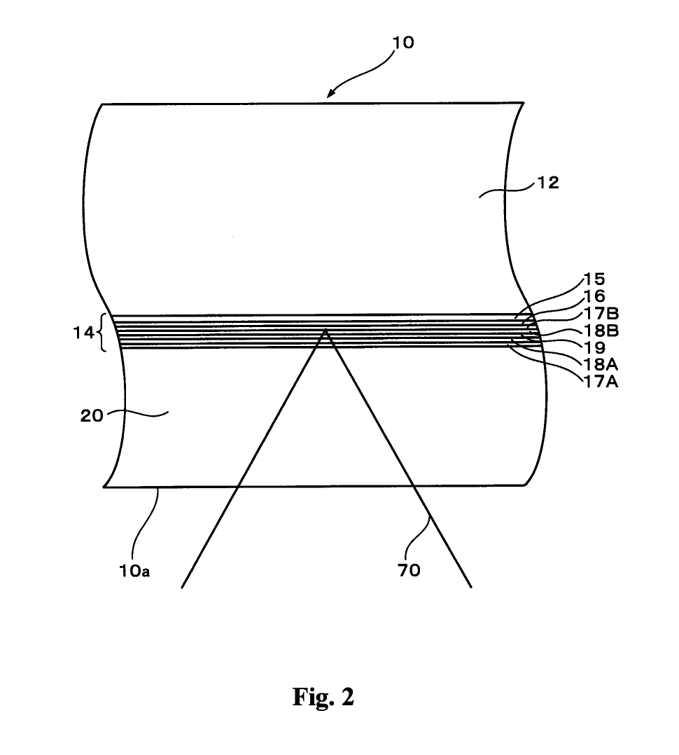

FIG. 2 is an enlarged view of the cross-sectional layer structure of this optical recording medium 10. The optical recording medium 10 has a disc shape with an outer diameter of approximately 120 mm and a thickness of approximately 1.2 mm. This optical recording medium 10 is composed of, from a light incident surface 10a side, the cover layer 20, the recording and reading layer 14, and the support substrate 12. Further, information can be recorded on the recording and reading layer 14. Examples of the recording and reading layer 14 include a write-once recording and reading layer, which allows information to be written thereon only once and not rewritable, and a rewritable recording and reading layer, which allows the rewriting of information. However, here, a write-once recording and reading layer will be used as an example.

The support substrate 12, which is a substrate for ensuring the thickness (approximately 1.2 mm) that is required to serve as an optical recording medium, has a disc shape with a thickness of 1.1 mm and a diameter of 120 mm. Spiral grooves and lands for guiding the beam 70 are formed on the surface on the light incident side from the vicinity of the center of the surface toward the outer periphery thereof. Various kinds of material may be used as the material for the support substrate 12, such as a glass, a ceramic, and a resin. Among these, from the perspective of ease of molding, a resin is preferred. Examples of the resin include a polycarbonate resin, an olefin resin, an acrylic resin, an epoxy resin, a polystyrene resin, a polyethylene resin, a polypropylene resin, a silicone resin, a fluororesin, an ABS resin, and a urethane resin. Among these, from a perspective such as workability, a polycarbonate resin, and an olefin resin are especially preferred. The support substrate 12 does not have to have a high light transmittance, since the support substrate 12 does not serve as a light path for the beam 70. In the present embodiment, the pitch of the groove and land is 0.32 μm. Although the thickness of the support substrate 12 is not especially limited, the thickness thereof is preferably in the range of 0.05 to 2.4 mm. If the thickness is less than 0.05 mm, it becomes difficult to mold the substrate due to its low strength. On the other hand, if the thickness is more than 2.4 mm, the mass of the optical recording medium increases, which makes it more difficult to handle. Although the shape of the support substrate 12 is also not especially limited, usually it is a disc shape, a card shape, or a sheet shape.

The recording and reading layer 14 formed on the support substrate 12 is configured by stacking, in order from the support substrate 12 side, a reflection film 15, a barrier layer 16, a second dielectric film 17B, a second Si recording layer 18B, a Cu recording layer 19, a first Si recording layer 18A, and a first dielectric film 17A.

An alloy having Ag as a main component is used for the reflection film 15. Here, an Ag—Nd—Cu alloy is used. The thickness of the reflection film 15 is preferably set, for example, between 5 to 300 nm, and especially preferably 20 to 200 nm. If the thickness of the reflection film 15 is less than 5 nm, a reflection function cannot be sufficiently obtained. On the other hand, if the thickness of the reflection film 15 is more than 300 nm, the deposition time increases, and the production properties dramatically deteriorate. Therefore, if the thickness is set in the above range, a reflection function and sufficient production properties can both be achieved. In the present embodiment, the thickness of the reflection film 15 is set to 80 nm. Further, although Ag is used as the main component of the reflection film 15 here, an alloy having Al as a main component may also be used.

The barrier layer 16 is a protective film for suppressing sulfuration of the metals, such as Ag, included in the reflection film 15. An alloy having ZnO as a main component is used for the barrier layer 16. Here, a ZnO—SnO—InO alloy is used. In the present embodiment, the thickness of the barrier layer 16 is set at 5 nm. Depending on the components included in the reflection film 15, this barrier layer 16 can be omitted.

In addition to the basic function of protecting the second Si recording layer 18B and the first Si recording layer 18A, the second dielectric film 17B and the first dielectric film 17A also have a function for enlarging a difference in the optical properties (degree of modulation) before and after the formation of a recording mark. To increase the difference in optical properties before and after recording mark formation, it is preferred to select as the material for the first and second dielectric films 17A and 17B a material having a high refractive index (n) in the wavelength region of the beam 70 that is used, specifically, the wavelength region of 380 nm to 450 nm (especially, 405 nm). Further, when the beam 70 is irradiated, if the energy that is absorbed by the first and second dielectric films 17A and 17B is large, the recording sensitivity tends to deteriorate. Therefore, to prevent this, as the material for the first and second dielectric films 17A and 17B, it is preferred to select a material having a low absorption coefficient (k) in the wavelength region of 380 to 450 nm (especially, 405 nm). In the present embodiment, a mixture of a sulfide and an oxide is used as the material for the first and second dielectric films 17A and 17B. More specifically, a mixture of ZnS and SiO₂ (molar ratio 80:20) is used.

Further, other materials may also be employed for the first and second dielectric films 17A and 17B, as long as such materials are a transparent dielectric material. Examples thereof include a dielectric material having an oxide, a sulfide, a nitride, or a combination thereof as a main component. It is preferred to include as a main component at least one kind of dielectric material selected from the group consisting of Al₂O₃, AlN, ZnO, ZnS, GeN, GeCrN, CeO, SiO, SiO₂, SiN, and SiC.

Further, considering the fact that the wavelength of the beam 70 is in the blue light wavelength region of 380 nm to 450 nm, it is preferred that the thickness of the first and second dielectric films 17A and 17B is 3 to 200 nm. If the thickness is less than 3 nm, it is difficult to obtain the function for protecting the second Si recording layer 18B, and the function for enlarging the difference in optical properties before and after recording mark formation. On the other hand, if the thickness is more than 200 nm, the deposition time increases, and the productivity may deteriorate. Here, the thickness of the second dielectric film 17B is set to 16 nm and the thickness of the first dielectric film 17A is set to 18 nm.

The second Si recording layer 18B, the Cu recording layer 19, and the first Si recording layer 18A are films onto which a recording mark is irreversibly formed due to these three layers interacting with each other. The second Si recording layer 18B, the Cu recording layer 19, and the first Si recording layer 18A are stacked adjacent to each other. When the beam 70 having a predetermined or greater power is irradiated, the three layers are chemically or physically modified by the heat from the beam, whereby the reflectivity of that region is changed. Although the cause of the change in reflectivity is unclear, it is speculated that the reflectivity changes due to the elements in the three layers, the second Si recording layer 18B, the Cu recording layer 19, and the first Si recording layer 18A, intermingling with each other either partially or totally at the surfaces where the layers contact each other. Consequently, the reflectivity with respect to the beam 70 at the portions where a recording mark is formed is very different from that at other portions (blank regions). As a result, data recording and reading can be achieved.

The material used for the first and second Si recording layers 18A and 18B has silicon (Si) as a main component. In the present embodiment, an example is illustrated in which the first and second Si recording layers 18A and 18B are configured from only Si. Further, Ge, Sn, Mg, In, Zn, Bi, Al and the like may also be included as addition elements.

It is preferred to set the thickness T2 of the second Si recording layer 18B to 0 nm<T2≦4 nm, and more preferably 1 nm≦T2≦4 nm. In the present embodiment, the thickness T2 of the second Si recording layer 18B is set to 3 nm.

It is preferred to set the thickness T1 of the first Si recording layer 18A to 0 nm<T1≦8.5 nm, and more preferably 3.5 nm≦T1≦8.5 nm. In the present embodiment, the thickness T1 of the first Si recording layer 18A is set to 5 nm.

As can be seen from the above numerical ranges, in the present embodiment it is preferred to set the thickness so that T1>T2. The specific basis for these numerical ranges will be described below.

The material used for the Cu recording layer 19 has Cu as a main component. Specifically, to Cu as a main component, one element or two or more elements such as Zn, Ni, Mg, Al, Ag, Au, Si, Sn, Ge, P, Cr, Fe, and Ti may be added. In the present embodiment, a Cu—Al—Zn—Ni structure is employed. Although the thickness of the Cu recording layer 19 is not especially limited, to sufficiently increase the change in reflectivity before and after the laser light is irradiated, the ratio with the thickness T1 of the first Si recording layer 18A (first Si recording layer 18A thickness T1/Cu recording layer 19 thickness) is preferably 0.2 to 5.0. In the present embodiment, a thickness of 5.5 nm, which is close to the thickness of the first Si recording layer 18A, is employed.

Further, the term “main component” in the present embodiment means that the content of that material is larger than any of the other components, or is included in a mole ratio of 50% or more.

The cover layer 20 is for protecting the recording and reading layer 14, and is made of a light-transmitting acrylic UV-curable resin. Although the thickness of the cover layer 20 is not especially limited, it is preferably 1 to 200 μm. Here, the thickness is 100 μm. If the thickness of the cover layer 20 is less than 1 μm, it is difficult to protect the recording and reading layer 14. On the other hand, if the thickness of the cover layer 20 is more than 200 μm, it is difficult to control the thickness of the cover layer 20 and difficult to ensure the mechanical accuracy of the whole optical recording medium 10.

When recording information on the optical recording medium 10, as illustrated in FIG. 2, the intensity-modulated beam 70 is caused to be incident on the optical recording medium 10 from the light incident surface 10a side of the cover layer 20, so as to be irradiated on the recording and reading layer 14. When the beam 70 is irradiated on the recording and reading layer 14, the recording and reading layer 14 heats up, and the respective elements (Si, Cu, Si) constituting the second Si recording layer 18B, the Cu recording layer 19, and the first Si recording layer 18A intermingle among each other. This mixed portion becomes a recording mark, whose reflectivity is a different value from the reflectivity of the other portions (blank regions).

Next, the method for manufacturing the optical recording medium 10 will be described.

First, the support substrate 12 formed with grooves and lands is produced by injection molding using a stamper. However, production of the support substrate 12 is not limited to the injection molding method. A 2P method or some other methods may also be used.

Next, the reflection film 15 is formed on the surface of the support substrate 12 on the side provided with the grooves and lands. This formation is carried out using vapor-phase epitaxy that utilizes a chemical species including silver (Ag) as a main component, for example, a sputtering method or a vacuum deposition method. It is especially preferred to use a sputtering method. Subsequently, the barrier layer 16 is formed on the reflection film 15. It is also preferred to use vapor-phase epitaxy for the formation of the barrier layer 16. In addition, a vapor-phase epitaxy method utilizing a chemical species including a sulfide, an oxide, a nitride, a carbide, a fluoride or a mixture thereof may also be employed during the formation of the second dielectric film 17B on the barrier layer 16. Among such methods, it is preferred to use a sputtering method.

Next, the second Si recording layer 18B, the Cu recording layer 19, and the first Si recording layer 18A are formed on the second dielectric film 17B. These layers may also be formed by vapor-phase epitaxy, among which methods it is preferred to use a sputtering method.

Next, the first dielectric film 17A is formed on the first Si recording layer 18A. Similar to the second dielectric film 17B, the first dielectric film 17A is formed by vapor-phase epitaxy utilizing a chemical species including a sulfide, an oxide, a nitride, a carbide, a fluoride or a mixture thereof, which are preferable main components. Among such methods, it is preferred to use a sputtering method.

Lastly, the cover layer 20 is formed on the first dielectric film 17A. The cover layer is formed by applying a viscosity-adjusted acrylic or epoxy UV curable resin over the film 17A by spin coating, and then irradiating UV rays thereon to cure the resin. Further, instead of a UV curable resin, the cover layer 20 may also be formed by sticking a light-transmitting sheet formed from a light-transmitting resin onto the first dielectric film 17A using a bonding agent or a pressure-sensitive adhesive.

Although the above manufacturing method was described for the present embodiment, the present invention is not especially limited to the above-described manufacturing method. Other manufacturing techniques may also be employed.

The optical recording medium 10 according to the present embodiment includes, as the recording and reading layer 14, the Cu recording layer 19, the first Si recording layer 18A arranged adjacent to the cover layer 20 side of this Cu recording layer 19, and the second Si recording layer 18B arranged adjacent to the support substrate 12 side of the Cu recording layer 19. By employing this three-layer structure, the power margin property when recording information is improved.

Further, by setting the thickness T1 of the first Si recording layer 18A to be 3 nm≦T1≦8.5 nm and the thickness T2 of the second Si recording layer 18B to be 1 nm≦T2≦4 nm, the jitter during reading can be reduced while suppressing the optimum recording power to be as small as possible.

### Example

Information was recorded onto the optical recording medium 10 according to the present embodiment while varying the recording power. The jitter and asymmetry during the reading of this information was evaluated, and based on this evaluation, the power margin property was evaluated. Here, “asymmetry” is the value calculated by dividing a value, which is obtained by subtracting the center level of the signal having the shortest period from the center level of the signal having the longest period, by the amplitude of the longest signal. Further, an LEQ (limit equalizer) was used for the jitter evaluation. As a reference for comparison, an optical recording medium was manufactured as a comparative example without the second Si recording layer 18B, and subjected to the same evaluation. In the evaluation of the power margin, the recording power at which the LEQ jitter is at a minimum (bottom jitter) is defined as the optimum recording power Po (Pₒₚₜᵢₘᵤₘ), and the actual recording power is defined as Pw. Then, Pw/Po is used as an evaluation standard. Further, the evaluation was carried out using an optical disc evaluation apparatus ODU-1000 (NA=0.85, λ=405 nm) manufactured by Pulstec Industrial Co., Ltd., under recording conditions of a modulation signal of (1, 7) RLL, a linear velocity during recording of 9.84 m/s, and a linear velocity during reading of 4.92 m/s.

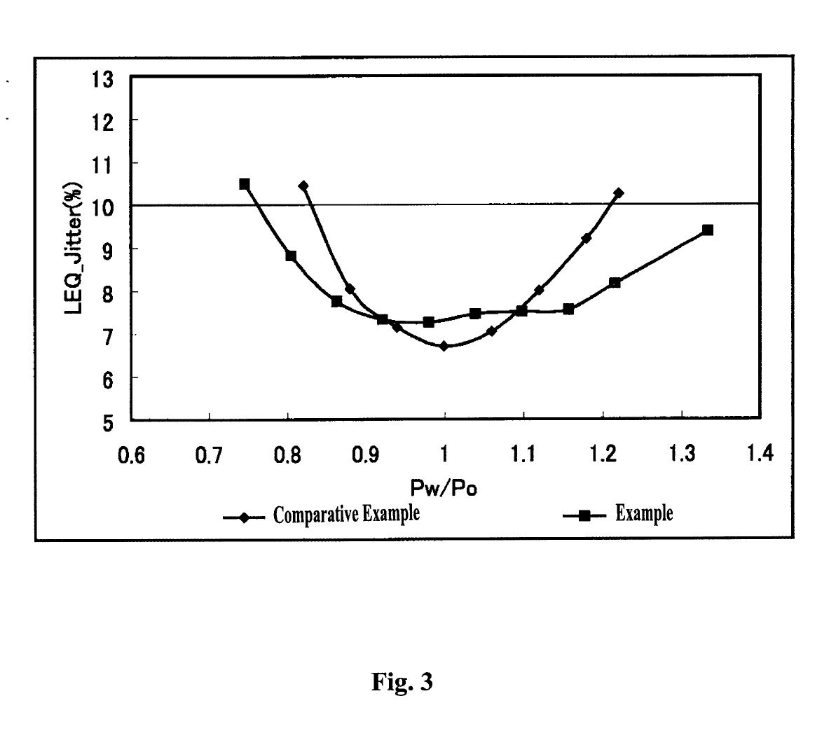

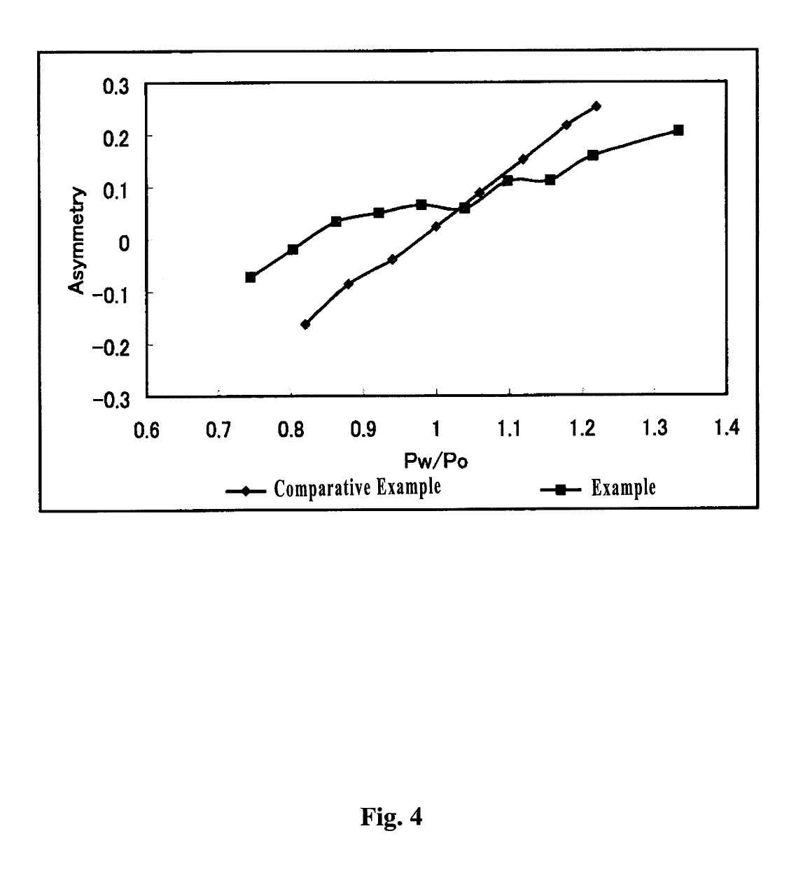

The thus-obtained jitter evaluation results are shown in FIG. 3, and the asymmetry evaluation results are shown in FIG. 4. From FIG. 3, it can be seen that, compared with the Comparative Example, the Example suppresses the worsening of jitter with respect to variation of the recording power better, and exhibits a substantial improvement in power margin. Further, from FIG. 4, it can be seen that, compared with the Comparative Example, the Example suppresses variation in asymmetry with respect to variation of the recording power, and that due to this point too, also exhibits a substantial improvement in power margin. More specifically, a large difference in the power margin arises depending on the presence of the second Si recording layer 18B.

### Verification Example

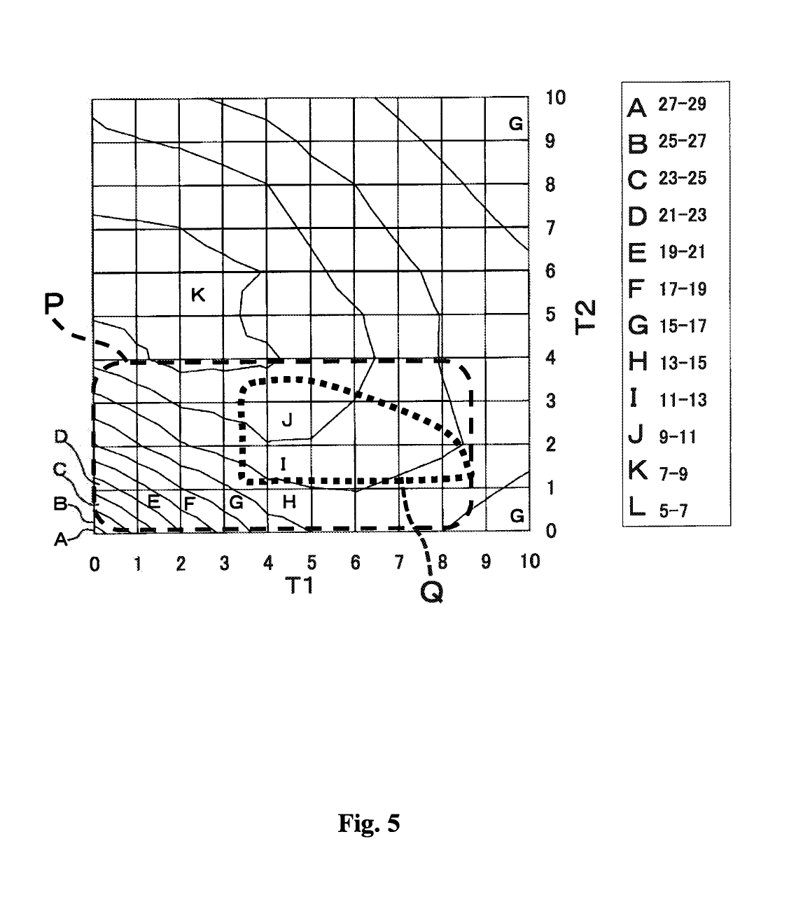

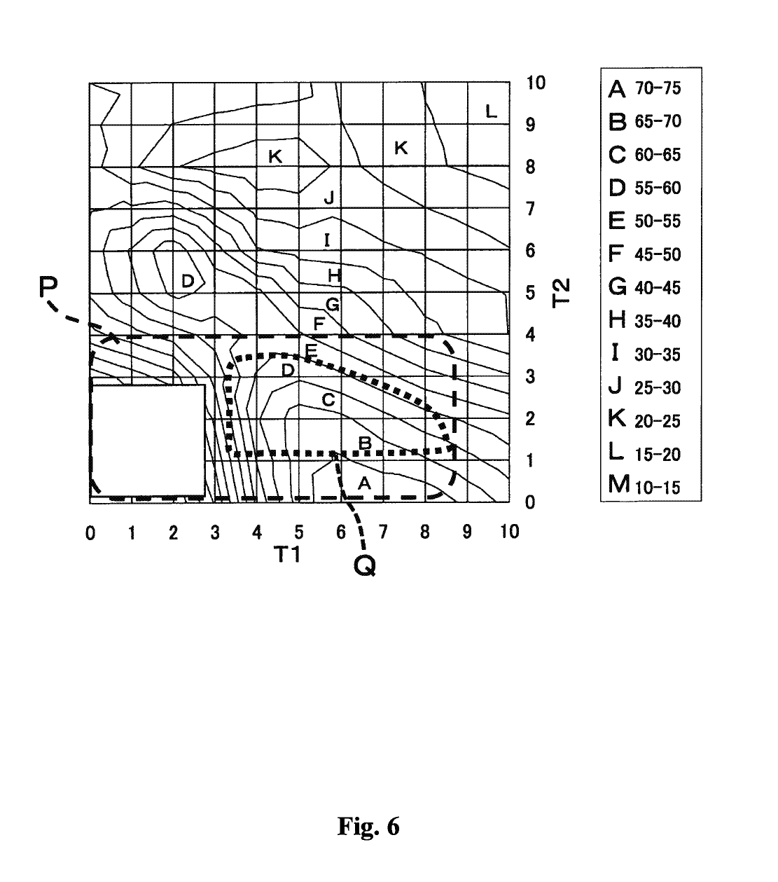

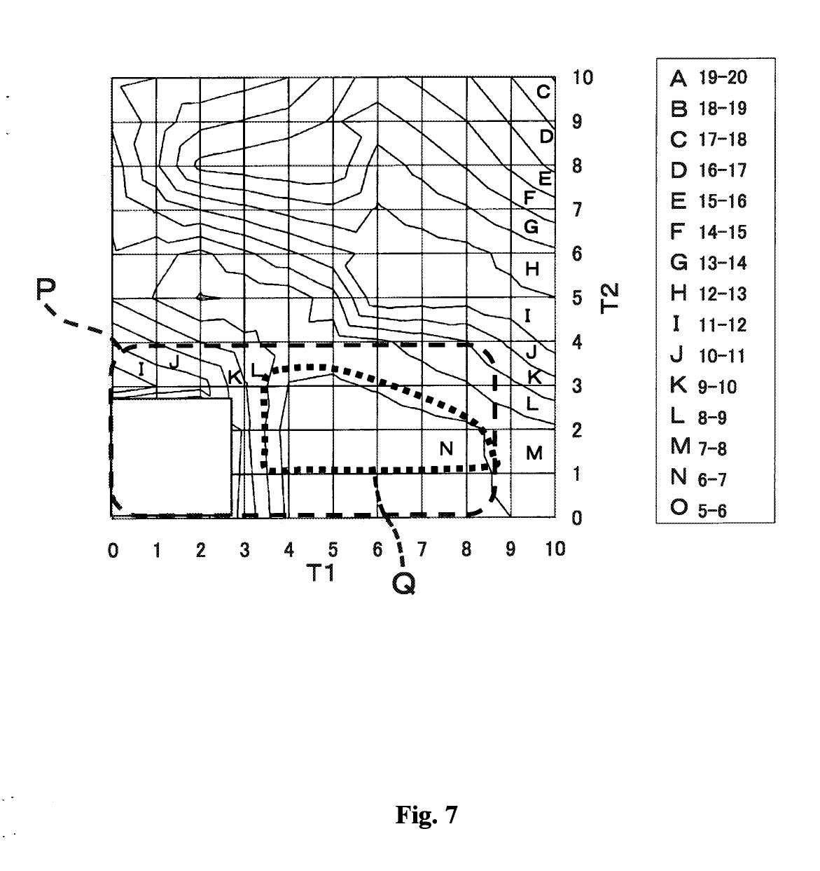

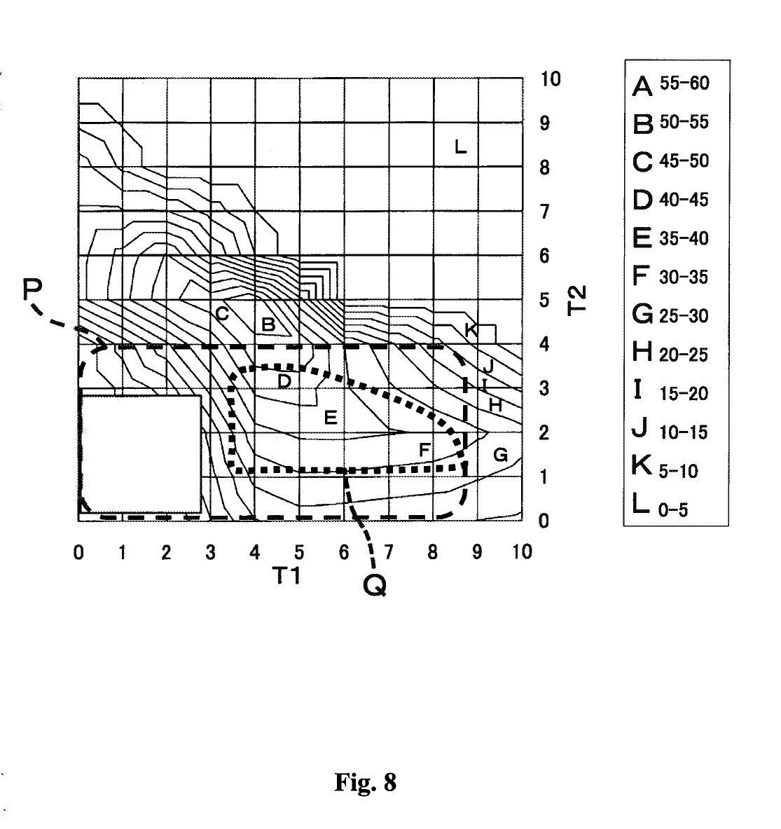

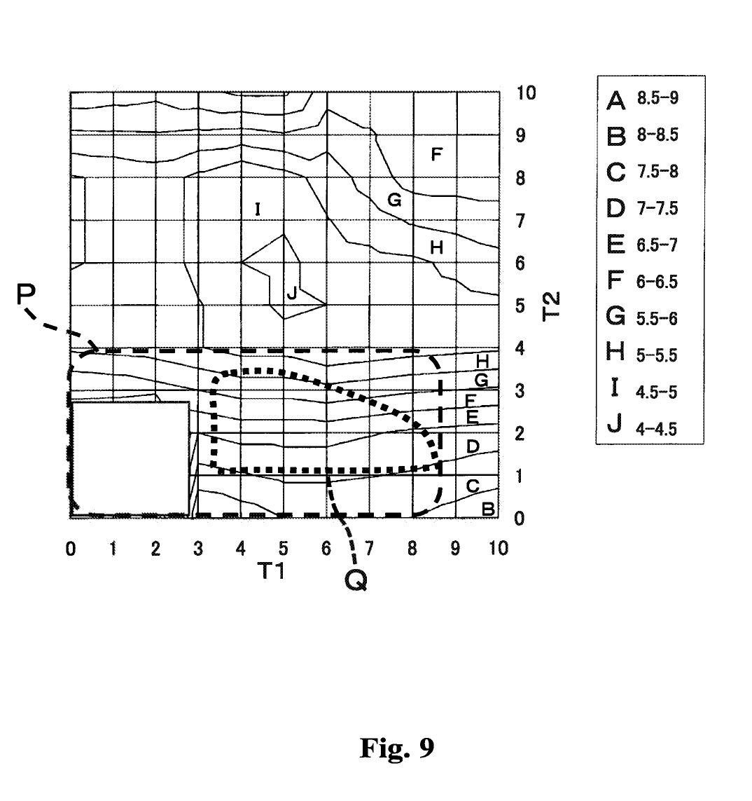

Using the optical recording medium 10 according to the present embodiment in which the Cu recording layer 19 was formed from only Cu without any addition elements, 100 media were manufactured by the combinations of the thicknesses of the first and second Si recording films 18A and 18B by varying the thickness of the second Si recording layer 18B in 1 nm steps between 0 to 10 nm while simultaneously varying the thickness of the first Si recording layer 18A in 1 nm steps between 0 to 10 nm. The recording and reading properties of these media were evaluated. The evaluation items were reflectivity during an unrecorded state (FIG. 5), degree of modulation during optimum recording power Po (FIG. 6), minimum value of LEQ jitter (bottom jitter) (FIG. 7), power margin (FIG. 8), and optimum recording power Po (FIG. 9). Evaluation was carried out by mapping the results as contour lines on a matrix with the thickness T1 of the first Si recording layer 18A on the horizontal axis and the thickness T2 of the second Si recording layer 185 on the vertical axis.

Further, the power margin value was obtained by, with the optimum recording power Po as a reference, varying the recording power Pw in both the stronger and weaker directions, taking the times when the LEQ jitter exceeded 10% as respectively the minimum recording power P_{under} and the maximum recording power Pₒᵥₑᵣ and dividing (Pₒᵥₑᵣ−P_{under}) by Po. The specific evaluation methods were the same as in the Example.

It can be seen from the unrecorded state reflectivity illustrated in FIG. 5 that the region in which the reflectivity falls within a preferable range of 10% or more, specifically, the region from A to J (midway through J), spreads out toward the lower and right sides in the map. More specifically, it can be seen that in the region in which the thickness T2 of the second Si recording layer 18B is 4 nm or less, a sufficient reflectivity can be obtained anywhere in the region in which the thickness T1 of the first Si recording layer 18A is 0 to 10 nm. Further, it can also be seen that if the thickness T1 of the first Si recording layer 18A is 3.5 nm or more, regardless of the thickness T2 of the second Si recording layer 183, a stable and sufficient reflectivity of 10% or more can be obtained. More specifically, from a reflectivity perspective, the conditions of 3 nm≦T1 and T2≦4 nm can be defined as preferable ranges.

On the other hand, the combination of the region in which the thickness T1 of the first Si recording layer 18A is less than 3 nm and the region in which the thickness T2 of the second Si recording layer 18B is more than 4 nm causes reflectivity to decrease to less than 10%, and is thus not very desirable.

From FIG. 6, it can be seen that the region in which the degree of modulation falls within a preferable range of 55% or more, specifically, the region from A to D, spreads out toward the lower right side in the map. Specifically, a sufficient degree of modulation can be obtained in the region in which the thickness T2 of the second Si recording layer 183 is 4 nm or less and the thickness T1 of the first Si recording layer 18A is 3.5 nm or more. More specifically, from a degree of modulation perspective, the conditions of 3.5 nm≦T1 and T2≦4 nm can be defined as preferable ranges.

From FIG. 7, it can be seen that the region in which bottom jitter falls within a preferable range of 7% or less, specifically, the region of N and O, spreads out toward the lower right side in the map. Specifically, a sufficient bottom jitter can be obtained in the region in which the thickness T2 of the second Si recording layer 18B is 4 nm or less and the thickness T1 of the first Si recording layer 18A is 3.5 nm or more. More specifically, from a bottom jitter perspective, the conditions of 3.5 nm≦T1 and T2≦4 nm can be defined as preferable ranges.

From FIG. 8, it can be seen that the region in which the power margin falls within a preferable range of 25% or more, specifically, the region from A to G, spreads out concentrically from the center of the map. Further, it can be seen that the region L, in which the power margin is less than 5%, which is extremely narrow, spreads out over a wide range toward the upper right in the map. In addition, examples of the region from H to L, in which the power margin is less than 25%, include the case where the thickness T2 of the second Si recording layer 18B is less than 1 nm, More specifically, the power margin tends to improve if the thickness T2 of the second Si recording layer 18B is 1 nm or more, more preferably 1.5 nm or more, and even more preferably 2 nm or more. On the other hand, it can be seen that when the thickness T1 of the first Si recording layer 18A is 3.5 nm or more, the power margin stabilizes (the contour line interval is wide) if the thickness T2 of the second Si recording layer 18B is 5 nm or less, and more preferably 4 nm or less for ensuring the stabilization. However, when the thickness T1 of the first Si recording layer 18A is more than 8.5 nm, it is difficult to obtain a power margin of 25% or more unless the thickness T2 of the second Si recording layer 18B is set within a narrow range in the vicinity of 2 nm. Therefore, considering errors and the like during film formation, it is not very desirable for the thickness T1 of the first Si recording layer 18A to exceed 8.5 nm. More specifically, from a power margin perspective, the conditions of 1 nm≦T2≦4 nm and 3.5 nm≦T1≦8.5 nm can be defined as preferable ranges. Further, it can also be seen that these conditions can fit within the ranges of the above-described conditions for reflectivity, degree of modulation, and bottom jitter.

From FIG. 9, it can be seen that the change in the optimum recording power is dependent on the thickness T2 of the second Si recording layer 18B. A smaller optimum recording power means a better recording sensitivity of the recording and reading layer 14. The region from D to J, in which the recording power is 7.5 W or less, is preferred for the optimum recording power Po. Therefore, the optimum recording power Po can be reduced if the thickness T2 of the second Si recording layer 18B is 1 nm or more, and more preferably 2 nm or more. More specifically, based on the optimum recording power conditions, the condition of 1 nm≦T2 nm can elicit preferable effects.

In FIGS. 6 to 9, the combined region of the thickness T1 of the first Si recording layer 18A of less than 3 nm and the thickness T2 of the second Si recording layer 18B of less than 3 nm is excluded from the evaluation target, since even the formation of the recording mark is unstable.

Region P, which satisfies the conditions of FIGS. 5 to 9, and region Q, which satisfies more preferable conditions, are superimposed on each of these drawings. For region P, it can be seen that the thickness T1 of the first Si recording layer 18A is set to 0 nm<T1≦8.5 nm and the thickness T2 of the second Si recording layer 18B is set to 0 nm<T2≦4 nm. For region Q, it can be seen that the thickness T1 of the first Si recording layer 18A is set to 3.5 nm≦T1≦8.5 nm and the thickness T2 of the second Si recording layer 18B is set to 1 nm≦T2≦4 nm. Further, based on the overall verification results, it can also be seen that it is preferred to set the thickness T2 of the second Si recording layer 18B to be smaller than the thickness T1 of the first Si recording layer 18A.

Although the optical recording medium 10 according to the present embodiment was described for a case in which the present invention is applied to a write-once optical recording medium, the present invention may also be applied to optical recording media that employ other recording methods. However, when applying to a rewritable optical recording medium, the recording and reading layer 14 needs to be preheated so that the whole structure is crystallized. On the other hand, since the present invention has the advantage of enabling a recording mark to be directly formed without undergoing such a step, it can be said that it is preferable to apply the present invention to a write-once optical recording medium.

Further, although the optical recording medium 10 according to the present embodiment forms a single recording film with a three-layer structure including a Cu recording layer and first and second Si recording layers to be arranged either side of the Cu recording layer, as long as the gist of the present invention is satisfied, a recording layer formed from other materials may be provided near this three-layer structure.

In addition, in the present embodiment, although only a case in which the wavelength region of the beam 70 used in optical recording and reading is 380 nm to 450 nm was described, the present invention is not limited to this. The wavelength region is, for example, preferably 250 nm to 900 nm.

Moreover, in the present embodiment, although only a case in which the recording and reading layer 14 is a single layer was described, the present invention is not limited to this. For example, a plurality of recording and reading layers 14 may be provided. In such a case, it is preferred that each recording and reading layer has at least a three-layer structure including a Cu recording layer and first and second Si recording layers to be arranged either side of the Cu recording layer.

The optical recording medium according to the present invention is not limited to the above-described embodiment. Obviously, various changes may be carried out as long as such changes do not depart from the gist of the present invention.

The optical recording medium according to the present invention can be applied in various optical recording media including a multilayer structure.

The entire disclosure of Japanese Patent Application No, 2010-069484 filed on Mar. 25, 2010 including specification, claims, drawings, and summary are incorporated herein by reference in its entirety.

1. An optical recording medium comprising:
a substrate;
a cover layer;
a Cu recording layer that is arranged between the substrate and the cover layer and includes Cu as a main component;
a first Si recording layer that is arranged adjacent to a cover layer side of the Cu recording layer and includes Si as a main component; and
a second Si recording layer that is arranged adjacent to a substrate side of the Cu recording layer and includes Si as a main component.

2. The optical recording medium according to claim 1, wherein the second Si recording layer has a thickness T2 that is set to 0 nm<T2≦4 nm.

3. The optical recording medium according to claim 2, wherein the second Si recording layer has a thickness T2 that is set to 1 nm≦T2≦4 nm.

4. The optical recording medium according to claim 1, wherein the first Si recording layer has a thickness T1 that is set to 0 nm<T1≦8.5 nm.

5. The optical recording medium according to claim 4, wherein the first Si recording layer has a thickness T1 that is set to 3.5 nm≦T1≦8.5 nm.

6. The optical recording medium according to claim 1, wherein a thickness T2 of the second Si recording layer is set to be smaller than a thickness T1 of the first Si recording layer.

7. The optical recording medium according to claim 4, wherein the thickness T2 of the second Si recording layer is set to be smaller than the thickness T1 of the first Si recording layer.

8. The optical recording medium according to claim 5, wherein the thickness T2 of the second Si recording layer is set to be smaller than the thickness T1 of the first Si recording layer.

9. The optical recording medium according to claim 1, further comprising:
a first dielectric layer that is arranged adjacent to the cover layer side of the first Si recording layer; and
a second dielectric layer that is arranged adjacent to the substrate side of the second Si recording layer.

10. The optical recording medium according to claim 4, further comprising:
a first dielectric layer that is arranged adjacent to the cover layer side of the first Si recording layer; and
a second dielectric layer that is arranged adjacent to the substrate side of the second Si recording layer.

11. The optical recording medium according to claim 5, further comprising:
a first dielectric layer that is arranged adjacent to the cover layer side of the first Si recording layer; and
a second dielectric layer that is arranged adjacent to the substrate side of the second Si recording layer.

12. The optical recording medium according to claim 6, further comprising:
a first dielectric layer that is arranged adjacent to the cover layer side of the first Si recording layer; and
a second dielectric layer that is arranged adjacent to the substrate side of the second Si recording layer.

13. The optical recording medium according to claim 7, further comprising:
a first dielectric layer that is arranged adjacent to the cover layer side of the first Si recording layer; and
a second dielectric layer that is arranged adjacent to the substrate side of the second Si recording layer.

14. The optical recording medium according to claim 8, further comprising:
a first dielectric layer that is arranged adjacent to the cover layer side of the first Si recording layer; and
a second dielectric layer that is arranged adjacent to the substrate side of the second Si recording layer.

15. An optical recording method for recording information by irradiating a laser beam on an optical recording medium having an information recording layer between a substrate and a cover layer, the method comprising:
providing, as the information recording layer, a Cu recording layer that includes Cu as a main component, a first Si recording layer that is arranged adjacent to a cover layer side of the Cu recording layer and includes Si as a main component, and a second Si recording layer that is arranged adjacent to a substrate side of the Cu recording layer and includes Si as a main component; and
chemically or physically modifying the Cu recording layer, the first Si recording layer, and the second Si recording layer simultaneously by heat from the laser beam.
